(19) United States
(12) Patent Application Publication
(10) Pub. No.: US 2026/0110582 A1
(43) Pub. Date: Apr. 23, 2026

(54) DRY BLOCK TEMPERATURE CALIBRATOR

(71) Applicant: PRESYS INSTRUMENTOS E SISTEMAS LTDA, São Paulo (BR)

(72) Inventor: Vinicius José Gomes Nunes, São Paulo (BR)

(21) Appl. No.: 18/924,553

(22) Filed: Oct. 23, 2024

(51) Int. Cl. G01K 15/00; F25B 21/02; F25B 40/00

(52) U.S. Cl. CPC G01K 15/002; F25B 21/02; F25B 40/00

(57) ABSTRACT

The present invention patent application, belonging to the field of Instrumentation and industrial metrology, comprises a dry block temperature calibrator (6), which has a block (7), and a closed system comprising: two heat sinks (1) using water to cool the Peltier element (2), and consequently the cooling of the metal block (3) used to test/calibrate temperature sensors, a pump (24) that directs the water flow to the high-efficiency radiator (5), and then the water flow is recirculated to the heat sinks (1) concluding the closed system.

The present patent application for invention comprises a dry block temperature calibrator, which has a closed liquid cooling system to obtain negative temperatures with extreme speed and efficiency from heat sensors in large volumes of metal or liquid blocks.

### FIELD OF THE INVENTION

The application field is related to the field of Instrumentation and industrial metrology, used in dry block equipment, wherein it is necessary to lower temperatures of heat sensors.

### BACKGROUND OF THE INVENTION

BR 102021004078-5 refers to a device used for medical treatment to reduce located fat through the controlled freezing technique, which destroys fat cells, eliminating them, being a non-invasive treatment. The device promotes the exposure of a part of the skin to a temperature of minus 7° C. for a certain period of time, which causes the fat cells to be frozen and subsequently eliminated naturally by the body. The present device has as an innovation the Peltier cooling system through a heatsink combined with a fan, being specific mechanical means to replace the common use of gas and water cooling, resulting in greater efficiency, lower consumption of natural resources and ease of manufacture and maintenance.

BR 102012001582-0 refers to a thermostatically controlled water bath type fluid heat transfer equipment based on the Peltier Effect system, being constructed by two heat sinks, one below in contact with the heating face of the thermoelectric wafer and connected to a fan; and another heat sink, which is inserted in a heat-insulated container and which is coupled with the cooling side of the thermoelectric wafer and in contact with the fluid inserted in the heat-insulated container.

### SUMMARY OF THE INVENTION

The need for new equipment that can control temperature quickly and effectively is of great interest to the scientific community. Thus, the present patent application aims to develop a dry block temperature calibrator with a thermal cooling system for a Peltier element using liquid, which ensures negative temperatures more quickly and efficiently.

### ADVANTAGES OF THE INVENTION

Current Peltier element cooling systems are slow and dedicated to systems with low cooling volume, and work through air current flow. The minimum temperature reached is around 45° C., assuming an ambient temperature of 25° C., and only supports small volume blocks, in addition to a longer time to reach the extreme temperature of −45° C.

In this context, the great advantage of the invention is to provide a thermal cooling system for the Peltier element through pumped liquid that reaches an extreme temperature of −60°C., allowing the use of large volume blocks and allowing the use of liquid within the block, and reducing the time to reach extreme temperatures compared to conventional models.

### DETAILED DESCRIPTION OF THE FIGURES AND INVENTION

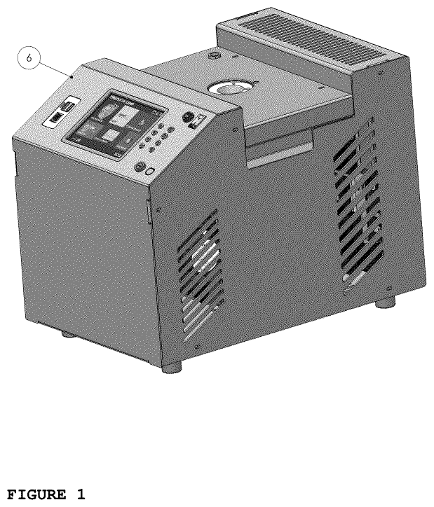

FIG. 1 is a schematic diagram of the overall structure of the low temperature dry block temperature calibrator (6) according to the present disclosure.

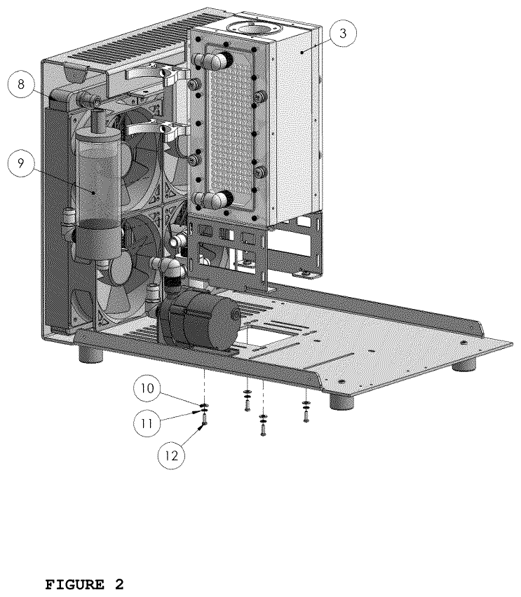

FIG. 2 is a schematic diagram of the thermal block (3) assembly, highlighting the reservoir (9), reservoir inlet connector (8) and the screw (12), spring washer (11) and plain washer (10) for fixing the block (3).

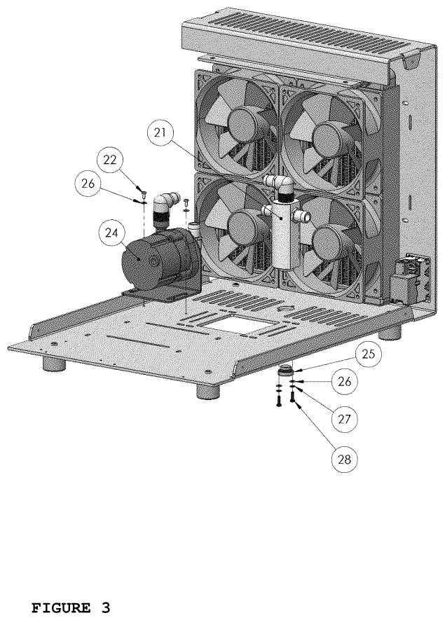

FIG. 3 is a schematic diagram of the pump assembly (24) with peripheral elements such as manifold (21), cover (25), reservoir drain, plain washer (26), spring washer (27), screw (28), pan head screw (22).

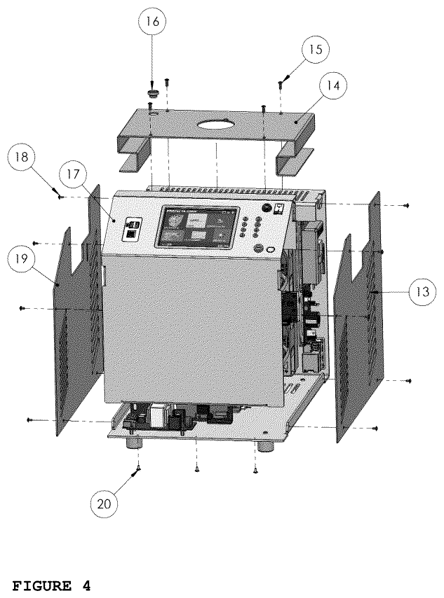

FIG. 4 is an exploded view of the temperature calibrator (6) with right cover (13), top cover (14), screw (15), drain cover (16), front panel (17), screw with washer (18), left cover (19) and screw with washer (20).

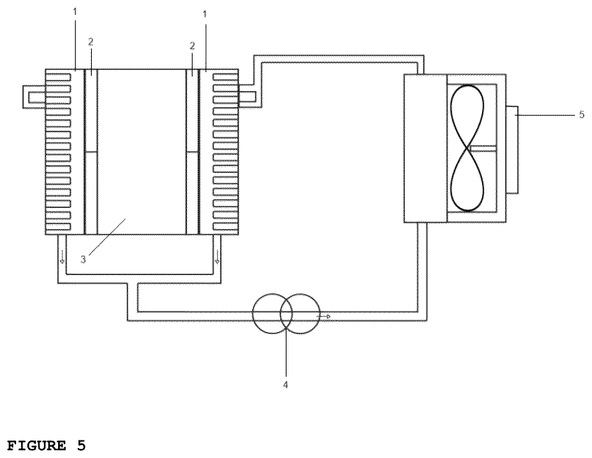

FIG. 5 illustrates the schematic of the Peltier element cooling system with pumped liquid of the present invention, wherein said closed system comprises: two heat sinks (1) using water to cool the Peltier element (2), and consequently the cooling of the metal block (3) used to test/calibrate temperature sensors, a pump (4) that directs the water flow to the high-efficiency radiator (5), and then the water flow is recirculated to the heat sinks (1) concluding the closed system.

1. A DRY BLOCK TEMPERATURE CALIBRATOR, comprising a heat block (3) with a Peltier element (2) on each side of the block (3), and a heat sink (1) coupled to each Peltier element (2) to perform heat exchange, wherein the cooling of the Peltier element (2) is performed by water, and consequently cooling the metal block (3) used to test/calibrate temperature sensors, a pump (24) that directs the water flow to the high-efficiency radiator (5), and then the water flow is recirculated to the heat sinks (1) concluding the closed system.
